(19) United States
(12) Patent Application Publication
(10) Pub. No.: US 2011/0305627 A1
(43) Pub. Date: Dec. 15, 2011

(54) PROCESSES FOR HYDROGEN PRODUCTION AND CATALYSTS FOR USE THEREIN

(76) Inventors: Nikunj Gupta, Sugar Land, TX (US); Mahesh Venkataraman Iyer, Houston, TX (US); Karel Martin Kapoun, Sugar Land, TX (US)

(21) Appl. No.: 13/141,272

(22) PCT Filed: Dec. 17, 2009
(86) PCT No.: PCT/US09/68456

§ 371 Date: Aug. 29, 2011

Related U.S. Application Data
(60) Provisional application No. 61/140,381, filed on Dec. 23, 2008.

(51) Int. Cl. C01B 3/16

(52) U.S. Cl. 423/655

(57) ABSTRACT

This invention describes a process for producing hydrogen comprising: introducing a feedstream comprising a bio-based feedstock and water into a reformer and supplying heat to the reformer; contacting the feedstream with a steam reforming catalyst disposed within the reformer to form a reformate comprising hydrogen and carbon monoxide; recovering the reformate from the reformer; contacting the reformate with steam in the presence of a water-gas shift catalyst disposed within a water-gas shift reaction zone to form a water-gas shift product stream comprising hydrogen, and the water-gas shift product stream comprises hydrogen in a greater quantity than in the reformate; heating the feedstream by heat exchange contact of the feedstream with a product stream selected from the reformate, the water-gas shift product stream or combinations thereof to transfer heat from the product stream to the feedstream prior to introducing the feedstream into the reformer.

This application claims priority to US Provisional Application No. 61/140381, filed on Dec. 23, 2008, which is herein incorporated by reference.

### FIELD

The invention relates to the production of hydrogen through steam reforming processes.

### BACKGROUND

As reflected in the patent literature, the production of electrical power in the most efficient manner with minimal waste is the focus of much research. For example, it is desirable to improve the efficiency in the production of electricity, separate and either use by-product carbon dioxide (CO₂) in other processes and/or minimize the CO₂ production. Therefore, attempts have been made to “boost” the effectiveness of fuels with hydrogen to improve fuel efficiency. In addition, electricity can be produced in fuel cells utilizing pure hydrogen. While fuel cells may be utilized with automobiles to reduce, if not eliminate the need for petroleum based fuel, such use requires a hydrogen source convenient to consumers (e.g., forecourt applications). Hydrogen for use in fuel cells may be formed by partial oxidation, autothermal reforming and steam reforming, for example.

Partial oxidation systems are based on combustion. Decomposition of the feedstock to primarily hydrogen and carbon monoxide (CO) occurs through thermal cracking reactions at high temperatures. Autothermal reforming is a variation on catalytic partial oxidation in which increased quantities of steam are used to promote steam reforming and reduce coke formation. However, both partial oxidation systems and autothermal reforming require oxygen, which reduces the ability of partial oxidation systems and autothermal reforming to be utilized for forecourt applications.

Steam reforming of hydrocarbon based feeds, such as methane and natural gas, has generally been the most cost effective process for the production of large volumes of hydrogen. However, the economics of natural gas reforming is strongly impacted by the cost of natural gas. Further, a large amount of carbon dioxide is produced from steam methane reforming (SMR), resulting in a large CO₂ footprint on the environment.

Therefore, it is desirable to develop processes for electricity production (and hydrogen production) whereby the CO₂ footprint is minimized and which may be utilized for forecourt applications.

### SUMMARY

The invention provides a process for producing hydrogen comprising: introducing a feedstream comprising a bio-based feedstock and water into a reformer and supplying heat to the reformer from a heat source to maintain the reformer at a reformer operation temperature; contacting the feedstream with a steam reforming catalyst disposed within the reformer to form a reformate comprising hydrogen and carbon monoxide; recovering the reformate from the reformer; contacting the reformate with steam in the presence of a water-gas shift catalyst disposed within a water-gas shift reaction zone to form a water-gas shift product stream comprising hydrogen, wherein the water-gas shift reactor operates at a water-gas shift operation temperature that is lower than the reformer operation temperature and the water-gas shift product stream comprises hydrogen in a greater quantity than in the reformate; heating the feedstream by heat exchange contact of the feedstream with a product stream selected from the reformate, the water-gas shift product stream or combinations thereof to transfer heat from the product stream to the feedstream prior to introducing the feedstream into the reformer.

### BRIEF DESCRIPTION OF DRAWINGS

FIG. 1 illustrates an embodiment of a hydrogen production process.

FIG. 2 illustrates an embodiment of a water-gas shift process.

FIG. 3 illustrates an embodiment of a hydrogen production process.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

Embodiments of the invention generally include processes for producing hydrogen. The processes generally include contacting steam and a feedstock with a steam reforming catalyst disposed within a reformer to form a reformate rich in hydrogen.

One or more embodiments utilize a biology based, hereinafter referred to as “bio-based,” feedstock. It is desirable to utilize bio-based feedstocks in an effort to decrease fuel costs (e.g., the cost of producing the feedstock), minimize impacts to the environment (both in the production of the feedstock and the use thereof) and provide sustainable feedstocks for hydrogen production, for example.

The bio-based feedstock may include alcohols, acids, ketones, ethers, esters, aldehydes or combinations thereof, for example. The alcohols may include methanol, ethanol, n-propanol, isopropyl alcohol, butanol or combinations thereof, for example. In one or more embodiments, the alcohol is ethanol (which may be referred to herein as bio-based ethanol when required to distinguish from hydrocarbon derived ethanol). The acids may include acetic acid, for example. The ketones may include acetone, for example.

In one or more embodiments, the bio-based feedstock is derived from biomass, such as lignin, corn, sugar cane, syrup, beet juice, molasses, cellulose, sorbitol, algae, glucose, acetates, such as ethyl acetate or methyl acetate or combinations thereof. As used herein, the term “biomass” excludes organic material which has been transformed by geological processes into substances, such as petroleum. In one or more embodiments, the bio-based feedstock is derived from biogas, such as that produced by anaerobic digestion or fermentation of biodegradable materials, including biomass, manure, sewage, energy crops or combinations thereof, for example. As used herein, the term “biogas” refers to a gas produced by the biological breakdown of organic matter in the absence of oxygen.

In one or more embodiments, the feedstock includes an oxygenate. As used herein, the term “oxygenate” refers to a compound containing at least one oxygen atom. It is contemplated that the oxygenates may be petroleum based or may be bio-based. However, one or more embodiments include bio-based oxygenates. In one specific embodiment, the bio based oxygenate is selected from acetone, acetic acid, n-propanol, isopropanol, ethyl acetate, methyl acetate, butanol, ethanol and combinations thereof, for example.

In addition to the feedstock, water is introduced into the reformer. The water may be introduced as steam. A majority of reforming processes include contacting the water and the feedstock thereby vaporizing the water, prior to entry into the reformer. Alternatively, the water may be introduced into the reformer separately from the feedstock.

Currently, ethanol is the most widely available bio-based feedstock. Production of bio-based ethanol generally includes fermentation and yields ethanol diluted with large amounts of water. For example, a “fuel” fermentation broth may have an ethanol content of less than 10 wt. %. Accordingly, bio-based ethanol is generally treated to remove at least a portion of the water prior to delivery. Treatment methods for removal of the water to produce fuel grade and chemical grade ethanol may include distillation and further separation of the water, such as via zeolite adsorption, for example. The cost of treatment significantly adds to the production cost of bio-based ethanol. For example, the treatment processes may result in over 50 percent of the actual utility cost in producing bio-based ethanol from fermentation based processes.

However, it has been discovered that extensive water removal from the fermentation broth is not necessary for operation with the embodiments described herein. In fact, it has been observed that aqueous feedstocks may increase the efficiency of the described reforming processes (and minimize or eliminate the need for separate water introduction into the reformer). Accordingly, one or more embodiments utilize aqueous bio-based feedstocks. The aqueous bio-based feedstock may include at least 5 wt. %, or at least 15 wt. %, or at least 20 wt. %, or at least 30 wt. %, or from 10 wt. % to 90 wt. % or from 20 wt. % to 80 wt. % water, for example.

It is common for bio-based feedstocks, such as bio-based alcohols, to include one or more denaturing agents. As used herein, the term “denaturing agent” refers to a compound utilized to render a feedstock toxic or undrinkable. Unfortunately, it has been observed that some denaturing agents can further decrease conversion of reforming processes. As used herein, the term “conversion” refers to the ability of a catalyst to convert the feed to products other than the feed. However, the extent of the decrease in conversion appears dependent upon the type of denaturing agent. For example, it has been observed that benzene, when utilized as a denaturing agent, can lead to a loss of catalyst activity (measured by the weight of hydrogen produced per weight of steam reforming catalyst used) and a resulting decrease in conversion. In contrast, methanol can be utilized as a denaturing agent with little to no effect on the catalyst activity (e.g., a reduction in catalyst activity of less than 5 percent, or less than 3 percent or less than 1 percent compared to an identical feedstock absent the denaturing agent). However, even when catalyst deactivation (i.e., loss of catalyst activity) occurs as a result of the denaturing agent, it has unexpectedly been observed that this deactivation can be reversed with one or more embodiments of the invention by switching the denaturing agent in the feedstock (without replacing the steam reforming catalyst). Accordingly, one or more embodiments of the invention result in reforming processes having little to no sensitivity to feedstock change (e.g., catalyst activity can be restored to commercially viable levels upon change of feedstock without shutdown of the reformer). Commercially viable catalyst activity levels depend upon and are determined by individual process parameters.

The reformer may include any reactor (or combination of reactors) capable of steam reforming a feedstock to produce a reformate comprising hydrogen. For example, the reactor may include a gas phase reactor (e.g., the feedstock is introduced into the reformer as vapor). Such processes are referred to herein as steam reforming processes. While it is desirable to utilize existing equipment to employ the embodiments described herein, it is contemplated that new plants/equipment may be designed and built to optimize the embodiments described herein.

Chemical equilibrium and heat transfer limitations are two factors governing the production of hydrogen within reforming processes. It is desirable to design and operate the reformer in a manner such that chemical equilibrium is reached, thereby resulting in maximum hydrogen production.

Historically, steam reformers (such as those utilizing methane and petroleum based ethanol feedstocks) have operated at high temperatures of at least 900° C., for example, to promote the forward equilibrium reaction and maintain sufficient process efficiency. As used herein, the term “efficiency” is measured per pass through the reformer by the following equation: (g H₂ product)/(g feed+net thermal heat+net power consumption).

Heat is generally supplied to the reformer from a heat source. The heat source may include those capable of supplying heat to steam reformers. However, one embodiment includes flameless distributed combustion (FDC). FDC enables efficient use of system energy and is generally accomplished by pre-heating combustion air and fuel gas sufficiently such that when the two streams are combined, the temperature of the mixture exceeds the auto-ignition temperature of the mixture. However, the temperature of the mixture is generally lower than that which would result in oxidation reactions upon mixing. See, U.S. Pat. No. 6,821,501 and U.S. Pat. Publ. No. 2006/0248800, which are incorporated by reference herein.

In one or more embodiments, the reformer may be operated at a reformer operation pressure of less than 300 psig, from 100 psig to 400 psig, or from 200 psig to 400 psig, or from 200 psig to 240 psig, or from 150 psig to 275 psig, or from 150 psig to 250 psig or from 150 psig to 225 psig, for example.

As discussed herein, the reformate is generally hydrogen rich (i.e., includes more than 50 mol. % hydrogen). In one or more embodiments, the reformate includes at least 60 mol. %, or at least 70 mol. %, or at least 95 mol. % or at least 97 mol. % hydrogen relative to the total weight of the reformate, for example. In addition to hydrogen, the reformate may further include by-products, such as carbon monoxide.

Additional hydrogen can be produced via a water gas shift reaction that converts carbon monoxide (CO) into carbon dioxide (CO₂). Therefore, the reformate may optionally be passed to a water-gas shift reaction zone where the process stream (e.g., the reformate) is further enriched in hydrogen by reaction of carbon monoxide present in the process stream with steam in a water-gas shift reaction to form a water-gas shift product stream having a greater hydrogen concentration than a hydrogen concentration of the reformate. For example, the water-gas shift product stream may include at least 97 mol. %, or at least 98 mol. % or at least 99 mol. % hydrogen relative to the weight of the water-gas shift product stream.

The water-gas shift reaction zone may include any reactor (or combination of reactors) capable of converting carbon monoxide to hydrogen. For example, the reactor may include a fixed-bed catalytic reactor. The water-gas shift reactor includes a water-gas shift catalyst. The water-gas shift catalyst may include any catalyst capable of promoting the water-gas shift reaction. For example, the water-gas shift catalyst may include alumina, chromia, iron, copper, zinc, the oxides thereof or combinations thereof. In one or more embodiments, the water-gas shift catalyst includes commercially available catalysts from BASF Corp, Sud Chemie or Haldor Topsoe, for example.

The water-gas shift reaction generally goes to equilibrium at the temperatures required to drive the reforming reaction (therefore, hindering the production of hydrogen from carbon monoxide). Therefore, the water-gas shift reactor typically operates at an operation temperature that is lower than reformer operation temperature (e.g., at least 50° C. less, or at least 75° C. less or at least 100° C. less). For example, the water-gas shift reaction may occur at a temperature of from about 200° C. to about 500° C., or from 250° C. to about 475° C. or from 275° C. to about 450° C., for example.

In one or more embodiments, the water-gas shift reaction is operated in a plurality of stages. For example, the plurality of stages may include a first stage and a second stage.

Generally, the first stage is operated at a temperature that is higher than that of the second stage (e.g., the first stage is high temperature shift and the second stage is a low temperature shift). In one or more embodiments, the first stage may operate at a temperature of from 350° C. to 500° C., or from 360° C. to 480° C. or from 375° C. to 450° C., for example. The second stage may operate at a temperature of from 200° C. to 325° C., or from 215° C. to 315° C. or from 225° C. to 300° C., for example. It is contemplated that the plurality of stages may occur in a single reaction vessel or in a plurality of reaction vessels.

It has been observed that many of the steam reforming catalysts optimized for petroleum based reforming processes (such as those utilized in steam methane reforming) do not provide sufficient conversion when reacted with ethanol (either bio-based or petroleum based) and/or other bio-based feedstocks. Desirably, the steam reforming process proceeds via dehydrogenation. However, a second reaction pathway may occur and includes dehydration. Dehydrogenation reaction pathways generally result in the ability of the reformate to undergo subsequent water-gas shift reactions at temperatures lower than the temperatures attainable with dehydration reaction pathways; thereby maximizing hydrogen production. In contrast, dehydration of ethanol leads to ethylene as a reactive intermediate, thereby increasing the potential for coke production (e.g., carbon deposits) within the reformer.

Coke buildup can result in lower steam reforming catalyst activity and therefore a shortened catalyst lifetime. Efforts to retard the dehydration reaction pathway have included utilizing high molar steam to carbon ratios (e.g., greater than 6:1) to increase hydrogen selectivity, thereby significantly increasing reforming heating costs. As used herein, the term “selectivity” refers to the percentage of feedstock converted to hydrogen. However, embodiments of the invention are capable of operation at lower molar steam to carbon ratios (e.g., less than 6:1) without the resulting loss in catalyst activity and increase in coke formation. For example, embodiments of the invention may utilize a steam to carbon (as measured by the carbon content in the feedstock) molar ratio of from 2.0:1 to 5:1, or from 2.5:1 to 4:1 or from 2.75:1 to 4:1, for example.

In addition to lower steam to carbon ratios, embodiments of the invention are capable of lower reformer operation temperatures, e.g., reformer operation temperatures of less than 900° C., or less than 875° C., or less than 850° C., or from 500° C. to 825° C. or from 600° C. to 825° C., for example, while maintaining adequate process efficiency (e.g., efficiencies within 20 percent, or 15 percent or 10 percent of the efficiency of an identical process operated at high temperatures). In some instances, the embodiments of the invention are capable of operation at lower reformer temperatures while exhibiting increased process efficiencies over identical processes operated at high reformer temperatures. For example, the embodiments of the invention may exhibit efficiencies of at least 5 percent greater, or at least 7 percent greater or at least 10 percent greater than identical high temperature processes.

Lower reformer temperatures (i.e., temperatures of less than 900° C.) can result in a lower utilities demand, lower construction material cost (due at least in part to a reduction in corrosion and stress on process equipment), a reduced CO₂ footprint (e.g., decreased CO₂ levels in the reformate), more favorable water gas shift equilibrium and increased hydrogen levels in the reformate, for example.

In one or more embodiments, the reformer includes a membrane type reactor, such as that disclosed in U.S. Pat. No. 6,821,501, which is incorporated by reference herein. The in-situ membrane separation of hydrogen employs a membrane fabricated from an appropriate metal or metal alloy on a porous ceramic or porous metal support.

Removal of hydrogen through the membrane allows the reformer to be run at temperatures lower than conventional processes. For example, the membrane type reactor may be operated at a temperature of from 250° C. to 700° C., or from 250° C. to 500° C. or from 250° C. to 450° C. It has been observed that such reformer operation temperatures provide for CO₂ selectivity (over CO selectivity) of near 100 percent, while higher temperatures, such as those utilized in conventional processes, provide for greater CO selectivity.

The membrane type reactor is generally operated at pressures sufficient to favor equilibrium. Moreover, such pressures drive the hydrogen through the membrane of the reformer.

It has been observed that reforming processes utilizing membrane type reactors are capable of producing hydrogen of high purity (e.g., at least 95 mol. % or at least 96 mol. %). Accordingly, one or more embodiments utilize a membrane type reactor, thereby eliminating the use of water gas shift reactions to further purify the reformate. The hydrogen is recovered as permeate without additional impurities that might affect performance in subsequent use. The remaining stream generally includes high concentration CO₂.

The reactor annulus is packed with steam reforming catalyst and equipped with a perm-selective (i.e., hydrogen-selective) membrane that separates hydrogen from the remaining gases as they pass through the catalyst bed. The membrane is generally loaded with the steam reforming catalyst.

Membranes suitable for use in the present invention include various metals and metal alloys on a porous ceramic or porous metallic supports. The porous ceramic or porous metallic support protects the membrane surface from contaminants and, in the former choice, from temperature excursions. In one or more embodiments, the membrane support is porous stainless steel. Alternatively, a palladium layer can be deposited on the outside of a porous ceramic or metallic support, in contact with the steam reforming catalyst.

The high purity hydrogen may be used directly in a variety of applications, such as petrochemical processes, without further reaction or purification. However, the reforming process may further include purification. The purification process may include separation, such as separation of the hydrogen from the reformate or water-gas shift product stream, to form a purified hydrogen stream. For example, the separation process may include absorption, such as pressure swing absorption processes which form a purified hydrogen stream and a tail gas. Alternatively, the separation process may include membrane separation to form a purified hydrogen stream and a carbon dioxide rich stream. One or more embodiments include both absorption and membrane separation.

The purified hydrogen stream may include at least 95 wt. %, or at least 98 wt. % or at least 99 wt. % hydrogen relative to the weight of the purified hydrogen stream, for example.

As described above, the feedstock generally contacts a steam reforming catalyst within the reformer, accelerating the formation of hydrogen. The steam reforming catalyst may include those catalysts capable of operating at equilibrium under steam reforming operation conditions. For example, the steam reforming catalyst may include those catalysts capable of operating at equilibrium under reformer operation temperatures of less than 900° C. In one or more embodiments, the steam reforming catalyst is selective to the dehydrogenation reaction pathway when utilizing ethanol as the feedstock (either petroleum based or bio-based).

The steam reforming catalyst generally includes a support material and a metal component, which are described in greater detail below. The “support material” as used herein refers to the support material prior to contact with the metal component and an optional “modifier”, also discussed in further detail below.

The support material may include transition metal oxides or other refractory substrates, for example. The transition metal oxides may include alumina (including gamma, alpha, delta or eta phases), silica, zirconia or combinations thereof, such as amorphous silica-alumina, for example. In one specific embodiment, the transition metal oxide includes alumina. In another specific embodiment, the transition metal oxide includes gamma alumina.

The support material may have a surface area of from 30 m²/g to 500 m²/g, or from 40 m²/g to 400 m²/g or from 50 m²/g to 350 m²/g, for example. As used herein, the term “surface area” refers to the surface area as determined by the nitrogen BET (Brunauer, Emmett and Teller) method as described in Journal of the American Chemical Society 60 (1938) pp. 309-316. As used herein, surface area is defined relative to the weight of the support material, unless stated otherwise.

The support material may have a pore volume of from 0.1 cc/g to 1 cc/g, or from 0.2 cc/g to 0.95 cc/g or from 0.25 cc/g to 0.9 cc/g, for example. In addition, the support material may have an average particle size of from 0.1 μ to 20 μ, or from 0.5 μ to 18 μ or from 1 μ to 15 μ (when utilized as in powder form), for example. However, it is contemplated that the support material may be converted into particles having varying shapes and particle sizes by pelletization, tableting, extrusion or other known processes, for example.

In one or more embodiments, the support material is a commercially available support material, such as commercially available alumina powders including, but not limited to, PURAL® Alumina and CATAPAL® Alumina, which are high purity bohemite aluminas sold by Sasol Inc.

The metal component may include a Group VIII transition metal, for example. As used herein, the term “Group VIII transition metal” includes oxides and alloys of Group VIII transition metals. The Group VIII transition metal may include nickel, platinum, palladium, rhodium, iridium, gold, osmium, ruthenium or combinations thereof, for example. In one or more embodiments, the Group VIII transition metal includes nickel. In one specific embodiment, the Group VIII transition metal includes nickel salts, such as nickel nitrate, nickel carbonate, nickel acetate, nickel oxalate, nickel citrate or combinations thereof, for example.

The steam reforming catalyst may include from about 0.1 wt. % to 60 wt. %, from 0.2 wt. % to 50 wt. % or from 0.5 wt. % to 40 wt. % metal component (measured as the total element, rather than the transition metal) relative to the total weight of steam reforming catalyst, for example.

One or more embodiments include contacting the support material or steam reforming catalyst with a modifier to form a modified support or modified steam reforming catalyst (which will be referred collectively herein as modified support). For example, the modifier may include a modifier exhibiting selectivity to hydrogen.

In one or more embodiments, the modifier includes an alkaline earth element, such as magnesium or calcium, for example. In one or more specific embodiments, the modifier is a magnesium containing compound. For example, the magnesium containing compound may include magnesium oxide or be supplied in the form of a magnesium salt (e.g., magnesium hydroxide, magnesium nitrate, magnesium acetate or magnesium carbonate).

The steam reforming catalyst may include from 0.1 wt. % to 15 wt. %, or from 0.5 wt. % to 14 wt. % or from 1 wt. % to 12 wt. % modifier relative to the total weight of support material, for example.

The modified support may have a surface area of from 20 m²/g to 400 m²/g, or from 25 m²/g to 300 m²/g or from 25 m²/g to 200 m²/g, for example.

In one or more embodiments, the steam reforming catalyst further includes one or more additives. In one or more embodiments, the additive is a promoter, for example. The promoter may be selected from rare earth elements, such as lanthanum. The rare earth elements may include solutions, salts (e.g., nitrates, acetates or carbonates), oxides and combinations thereof, for example.

The steam reforming catalyst may include from 0.1 wt. % to 15 wt. %, from 0.5 wt. % to 15 wt. % or from 1 wt. % to 15 wt. % additive relative to the total weight of steam reforming catalyst, for example.

In one or more embodiments, the steam reforming catalyst includes a greater amount of additive than modifier. For example, the steam reforming catalyst may include at least 0.1 wt. %, or at least 0.15 wt. % or at least 0.5 wt. % more additive than modifier. In another embodiment, the steam reforming catalyst includes substantially equivalent amounts of additive and modifier, for example.

Embodiments of the invention generally include contacting the support material (either modified or unmodified depending on the embodiment) with the metal component to form the steam reforming catalyst. The contact may include known methods, such as co-mulling the transition metal with the support material or impregnating the metal component into the support material.

One or more embodiments include a plurality of contact steps. For example, embodiments utilizing at least 10 wt. %, or at least 15 wt. % or at least 20 wt. % metal component relative to the total weight of catalyst may utilize a plurality of contact steps. In one or more embodiments, the catalyst preparation may include a sequence of contacting the support material and the metal component, drying the resulting compound and contacting the dried resulting compound with additional metal component, support material or combinations thereof.

The support material may be modified by contacting the support material with the modifier to form the modified support. Such contact can occur via known methods, such as by co-mulling the support material with the modifier, ion exchanging the support material with the modifier or impregnating the modifier within the support material, for example.

It is contemplated that one or more of the steps, such as contact of the support material with the modifier and the metal component, may be combined into a single step.

In one or more embodiments, the modified support is formed into particles. The particles may be formed by known methods, such as extrusion, pelleting or tableting, for example.

In one or more embodiments, the modified support material is dried. The modified support material may be dried at a temperature of from 150° C. to 400° C., or from 175° C. to 400° C. or from 200° C. to 350° C., for example.

In one or more embodiments, the steam reforming catalyst, the modified support or combinations thereof is calcined. It has been observed that calcinations at high temperatures (e.g., greater than 900° C.) may result in significant loss of surface area (e.g., resulting in surface areas as low as 10 m²/g). Accordingly, the calcinination may occur at a temperature of from 400° C. to 900° C., 400° C. to 800° C. or from about 400° C. to 700° C., for example. It has been observed that calcining results in a steam reforming catalyst that is stronger and more resistant to crushing. Further, calcination results in retardation of stream reforming catalyst deactivation within reforming processes, significantly increasing the steam reforming catalyst life over those catalysts not undergoing calcination. In addition, it has been observed that calcination of the modified support increases the surface area of the support material, thereby providing for greater metal component incorporation therein. For example, the surface area may increase at least 5 percent, or at least 7 percent or at least 10 percent over the surface area of the same modified support absent calcination.

One or more embodiments include a plurality of calcinations steps. For example, the catalyst preparation may include a sequence of calcining, drying and calcining.

In one or more embodiments, the modified support, the metal component, the steam reforming catalyst or combinations thereof are contacted with the one or more additives. The contact may include known methods, such as co-mulling, ion exchange or impregnation methods, for example.

While the reactions described herein have, in theory, the ability to produce a predetermined amount of hydrogen (the theoretical yield), the actual processes are constrained to producing hydrogen at a rate that is lower than the hypothetical yield. However, the processes described herein unexpectedly result in a conversion rate that is significantly greater than that of traditional processes (e.g., processes utilizing conventional steam reforming catalysts to convert ethanol to hydrogen at high temperatures). For example, the processes described herein result in a hydrogen yield (percentage of theoretical yield) of at least 60 percent, or at least 65 percent, or at least 70 percent, or at least 75 percent, or at least 80 percent, or at least 85 percent or at least 90 percent, for example. The processes may further exhibit an efficiency of at least 70 percent, or at least 75 percent, or at least 80 percent, or at least 85 percent or at least 90 percent, for example.

The hydrogen produced by the processes described herein may be utilized for any process requiring substantially pure hydrogen. For example, the hydrogen may be utilized in petrochemical processes or for fuel cells, for example.

A fuel cell is an energy conversion device that generates electricity and heat by electro-chemically combining a gaseous fuel, such as hydrogen, and an oxidant, such as oxygen, across an ion-conducting electrolyte. The fuel cell converts chemical energy into electrical energy. The use of fuel cells reduce emissions through their much greater efficiency, and so require less fuel for the same amount of power produced compared to conventional hydrocarbon fueled engines.

In one or more embodiments, the CO₂ produced by the formation of hydrogen may be utilized for high pressure injection into applications, such as oil recovery. Such applications enhance the oil and gas recovery process, while at the same time minimizing the carbon impact on the environment (the carbon monoxide/dioxide is turned into a non-volatile component within the earth).

It is further contemplated that the CO₂ formed by the processes described herein may be utilized in sequestration processes. For example, the CO₂ may be permanently stored so as to prevent release into the atmosphere.

As discussed previously herein, the feedstock is heated prior to introduction into the reformer. In addition, product streams (e.g., the reformate, the water-gas shift product stream or combinations thereof) may require chilling (e.g., a reduction of the temperature) prior to subsequent processes. Generally, steam reforming processes have included heat exchange of each process stream (e.g., feedstock and product streams) with an externally supplied heat exchange fluid (e.g., within a heat exchanger) to control the temperature thereof (either heating or chilling as required), thereby adding size and weight to the overall steam reforming system.

However, in one or more specific embodiments of the invention, the process includes contacting one or more of the process streams with another process stream (rather than an external heat exchange fluid) to exchange heat therebetween. For example, one or more embodiments include contacting the reformate with the feedstock prior to introduction into the reformer to transfer heat from the reformate to the feedstock (thereby heating the feedstock and cooling the reformate). The process may include contacting the water-gas shift product stream with the feedstock prior to introduction into the reformer. It is contemplated that while at least a portion of the heat exchange requirements of the process may be replaced by heat exchange contact between feedstreams and product streams within the process, a portion of the required heat exchange may be accomplished by contact with an externally supplied heat exchange fluid.

However, one or more specific embodiments include sequentially heating the feedstock by sequential contact with increasingly warmer product streams. For example, one or more specific embodiments include heat exchange contact with the water-gas shift product stream, such as the first stage water-gas shift product stream, the second water-gas shift product stream or combinations thereof, followed by heat exchange contact with the reformate as described previously.

The heat exchange contact may occur by passing the feedstock through a heat exchanger counter-current to the product stream, for example. In one or more embodiments, the feedstock passes counter-current to the product stream.

In addition to heating the feedstock, the heat exchange contact reduces the temperature of the reformate without the need for introduction of an outside heat or cooling source. However, when external heat exchange fluids are utilized within a portion of the process, it is contemplated that the heat exchangers utilizing the external heat exchange fluids will be smaller and require less power than those of conventional processes employing solely externally supplied heat exchange fluids due to the reduced temperature difference between the externally supplied heat exchange fluid and the process stream requiring heat exchange.

As discussed above, the feedstock may be introduced into the reformer as vapor. The feedstock is generally vaporized by pressurizing the feedstock to a pressure sufficient to vaporize the feedstock. Conventional steam reforming processes pressurize the feedstock within a compressor. However, it has been discovered that by utilizing the embodiments described herein, compression (e.g., pressurizing the feedstock within a compressor) can be eliminated. Rather, it has been observed that the heat exchange contact of the feedstock with the product stream(s) is sufficient to pressurize the feedstock prior to introduction into the reformer.

As discussed above, the reformer is generally heated by an external heat source. However, one or more embodiments of the invention utilize a process stream as a reformer heat source. For example, one or more specific embodiments utilize tail gas to at least partially heat the reformer. For example, the tail gas may be utilized directly (e.g., by recycling) to heat the reformer or may be utilized indirectly (e.g., by passing to a heat source for heat exchange contact with the heat exchange fluid) to heat the reformer. It is further contemplated that the tail gas may be further heated by heat exchange contact with a heat exchange fluid prior to direct heating of the reformer. Alternatively, one or more specific embodiments utilize the feedstock material, such as the bio-based feedstock, to at least partially heat the reformer. It is further contemplated that another process stream, such as a portion of the water-gas shift product stream, may be used to heat the reformer.

Further, as discussed above, steam reforming processes include introducing steam into the reformer. Generally, the steam is provided to the reforming process from an external source. However, one or more embodiments of the invention include utilizing condensate produced from the one or more heat exchangers as the steam for the reformer.

While the condensate is often in vapor form, it is contemplated that the condensate may be liquid when supplied to the reformer, thereby requiring vaporization prior to introduction into the reformer. Utilizing the condensate for at least a portion of the required steam minimizes the need for an external water supply, thereby reducing the overall process water consumption.

Unexpectedly, the processes described herein are capable of producing substantially “pure” hydrogen with a “single pass”, thereby requiring a smaller footprint. Accordingly, it is contemplated that the processes described herein may be utilized in small scale hydrogen production processes. For example, the processes described herein may be utilized in processes producing less 3 tons hydrogen/day, or less than 1 ton hydrogen/day, or less than 2000 kg hydrogen/day or less than 1500 kg/day. It is further contemplated that the processes described herein may be utilized in central and semi-central production processes (rather than distributed hydrogen production processes), for example.

It is further contemplated that the processes described herein may be utilized in forecourt scale applications. For example, the processes may be disposed at or in proximity to the point of dispensing to the consumer, such as at forecourt stations for fuel cell vehicles.

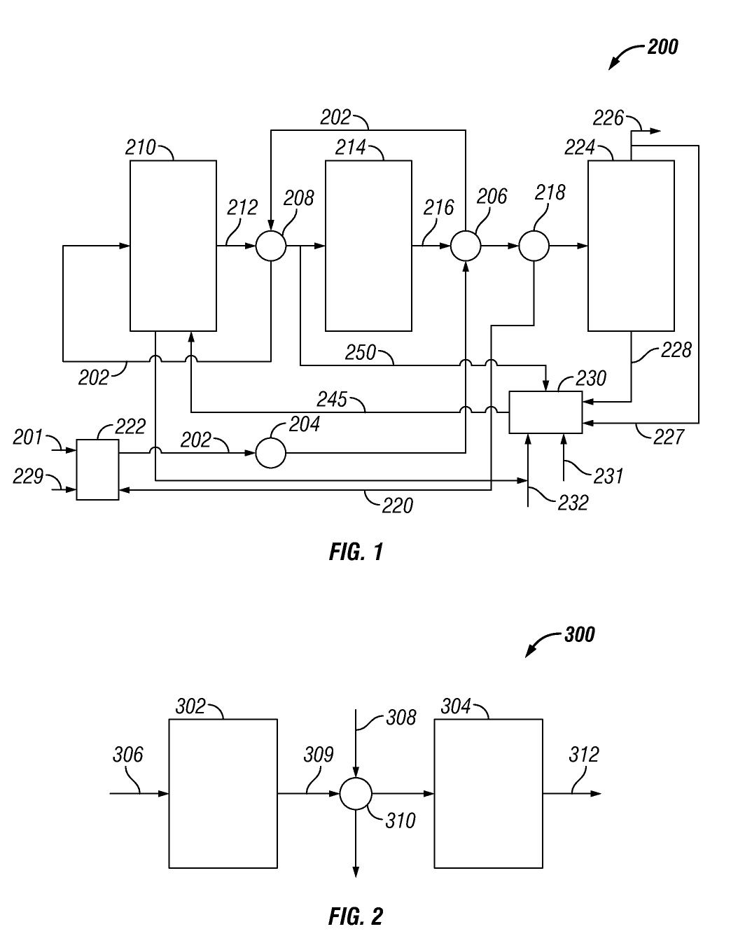

FIG. 1 illustrates a specific, non-limiting illustration of an embodiment of the invention. The process 200 generally includes preparing a feedstock 202 by introducing a bio-based feed 201 and water 229 into a feed preparation unit 222 to mix the bio-based feed 201 and water 229 to form the feedstock 202. The process 200 may further include passing the feedstock 202 through a pump 204 and then through a series of heat exchangers (206, 208). The feedstock 202 contacts increasingly warmer product streams, specifically the water-gas shift product stream 216 and then the reformate 212, to heat the feedstock 202 and cool the product streams 212 and 216. In addition, the feedstock 202 is generally vaporized by the heat exchange contact with the product streams 212 and 216.

The feedstock 202 flows counter-current to the product streams 212 and 216 through the plurality of heat exchangers 206 and 208. Upon heating/vaporization, the feedstock 202 is introduced into the reformer 210 to form the reformate 212. The reformate 212 passes through heat exchanger 208 for heat exchange contact with the feedstream 202 and into a water-gas shift reactor 214 to form the water-gas shift product stream 216.

The water-gas shift product stream 216 then passes through heat exchanger 206 for heat exchange contact with the feedstream 202. The water-gas shift product stream 216 may further pass through an additional heat exchanger 218 for further cooling prior to entry into a separation system 224 to form a purified hydrogen stream 226 and a bottoms stream 228. When the separation system 224 includes steam adsorption, the bottoms stream 228 is a tail gas. Condensate 220 may be recycled from heat exchanger 218 to combine with the feedstock 202 or the bio-based feed 201, thereby potentially reducing the external water consumption of the process 200. For example, the condensate 220 may be recycled from heat exchanger 218 to the feed preparation unit 222 to mix with the bio-based feed 201 and form the feedstock 202.

The bottoms stream 228, specifically the tail gas, can optionally be used as a fuel to a heat source 230 to provide heat 245 for the reformer 210. It is contemplated that external fuel sources 231, along with a gas stream 232 (e.g., air or oxygen), may be provided to the reformer 210 via the heat source 230. The external fuel sources may include those known in the art, such as fossil fuels or bio-based fuels, for example. It is further contemplated that at least a portion 250 of the reformate or a portion of the hydrogen 227 may be utilized as a fuel to the heat source 230. In addition, one or more embodiments include a hot (i.e., above room temperature) gas stream 232. Accordingly, one or more embodiments include contact between the hydrogen 227 and the gas stream 232 provide additional heat to the gas stream 232 (potentially eliminating yet another external source of heat) and cooling the hydrogen 227.

The processes described herein result in optimal process efficiency and lower ethanol consumption per unit of hydrogen produced compared to conventional steam reforming processes utilizing primarily external heat exchange fluids. Further, while it is contemplated that external fuel sources may be provided to heat the reformer, overall external fuel consumption by the process is significantly reduced compared to conventional processes.

FIG. 2 illustrates an embodiment of a water-gas shift reactor 300 utilizing a first stage 302 and a second stage 304. The reformate 306 passes through the first stage 302 to form a first stage water-gas shift product stream 309. The first stage water-gas shift product stream 309 then exchanges heat with the feedstock 308 within heat exchanger 310 prior to entering the second stage 304 to form second stage water-gas shift product stream 312.

### EXAMPLES

### Example 1

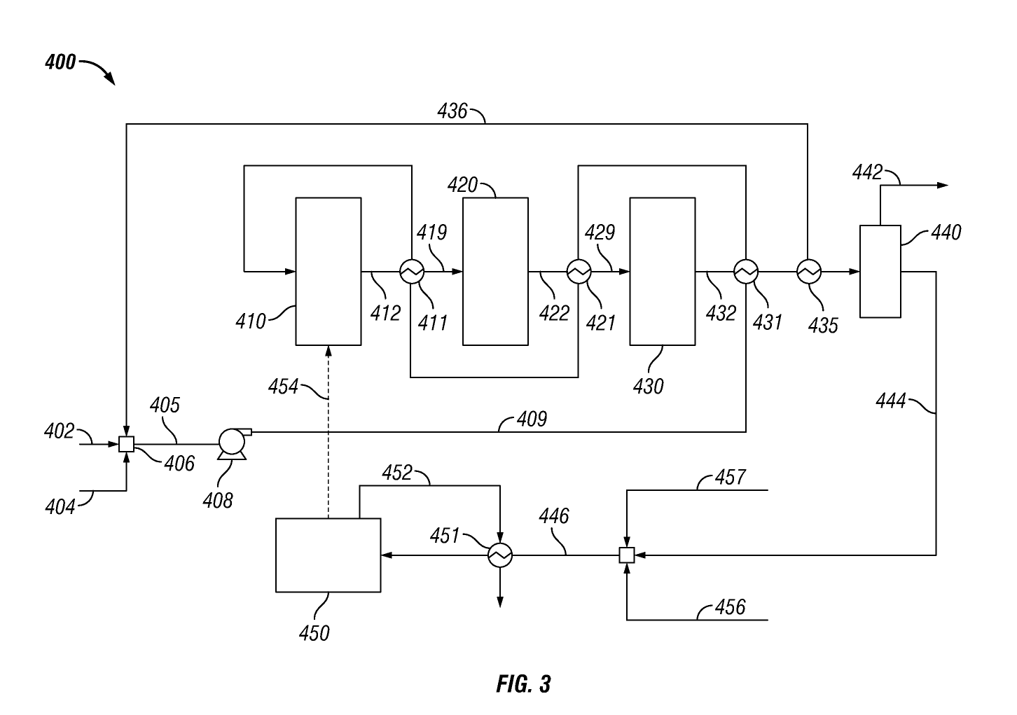

An Aspen modeling simulations was used to illustrate an embodiment of the invention and the process flow diagram is depicted in FIG. 3. The process 400 comprises a reformer 410, a high temperature water gas shift reactor 420, a low temperature water gas shift reactor 430, a pressure swing absorption apparatus 440 and a furnace 450. The bio-based feedstock used in this embodiment was ethanol 402 which was fed to pump 408 after being mixed with water 404 and recycled condensate 436. The ethanol water mixture 409 was heated by passing through a series of heat exchangers (431, 421 and 411). The ethanol/water mixture was then fed to the reformer 410. The reformate was cooled in heat exchanger 411 and passed to the high temperature water gas shift reactor 420. The high temerpature water gas shift product stream was then cooled through heat exchanger 421 and passed to the low temperature water gas shift reactor 430. The low temperature water gas shift product stream was further cooled by passing through exchangers 431 and 435 before it was passed to the PSA 440. The hydrogen was produced as stream 442 and the tail gas was combined with air, ethanol and natural gas before it was passed to furnace 450 which was used to provide heat 454 to the reformer 410.

Common Modeling Assumptions: The following assumptions were common to all of the simulations that were conducted. Simulations were conducted with Aspen Plus 10.2. Only the available default physical property parameters in Aspen were used. The specific physical property method used for all simulations was the NRTL (Renon)/Redlich-Kwong equation of state with Henry's law (NRTL-RK). The reformer was operated at 825° C. The low temperature water-gas shift reactor was operated at 418° C. The high temperature water-gas shift reactor was operated at 209° C. The entire system had a pressure of 225 psig.

The results of the simulation are shown in Table 1.

It was observed that the condensate recycle reduces the fresh water addition to the feedstock by 50 percent despite maintaining the steam to carbon ratio of the feedstock at 3:1. It was further observed that the overall system consumed 1.9 gallons of ethanol per kg of hydrogen produced resulting in a hydrogen yield of 67% percent (of the theoretical yield) and a theoretical process HHV efficiency of 83% percent. There was no external fossil fuel added to the system.

While the foregoing is directed to embodiments of the present invention, other and further embodiments of the invention may be devised without departing from the basic scope thereof and the scope thereof is determined by the claims that follow.

TABLE 1

| Mole fraction | Stream 409 | Stream 412 | Stream 422 | Stream 432 |
|---|---|---|---|---|
| H₂O | 0.857 | 0.395 | 0.333 | 0.309 |
| C₂H₆O | 0.143 | 0 | 0 | 0 |
| CO | 0 | 0.09 | 0.028 | 0.002 |
| CO₂ | 0 | 0.084 | 0.146 | 0.171 |
| H₂ | 0 | 0.418 | 0.48 | 0.504 |
| CH₄ | 0 | 0.013 | 0.013 | 0.013 |

1. A process for producing hydrogen comprising:
introducing a feedstream comprising a bio-based feedstock and water into a reformer and supplying heat to the reformer from a heat source to maintain the reformer at a reformer operation temperature;
contacting the feedstream with a steam reforming catalyst disposed within the reformer to form a reformate comprising hydrogen and carbon monoxide;
recovering the reformate from the reformer;
contacting the reformate with steam in the presence of a water-gas shift catalyst disposed within a water-gas shift reaction zone to form a water-gas shift product stream comprising hydrogen, wherein the water-gas shift reactor operates at a water-gas shift operation temperature that is lower than the reformer operation temperature and the water-gas shift product stream comprises hydrogen in a greater quantity than in the reformate;
heating the feedstream by heat exchange contact of the feedstream with a product stream selected from the reformate, the water-gas shift product stream or combinations thereof to transfer heat from the product stream to the feedstream prior to introducing the feedstream into the reformer.

2. The process of claim 1 wherein the bio-based feedstock comprises a material selected from the group consisting of alcohols, acids, ketones, ethers, esters, aldehydes, and combinations thereof.

3. The process of claim 1 wherein the bio-based feedstock is derived from biomass selected from the group consisting of lignin, corn, sugar cane, syrup, beet juice, molasses, cellulose, sorbitol, algae, glucose, acetates and combinations thereof.

4. The process of claim 1, wherein the bio-based feedstock comprises ethanol.

5. The process of claim 1, wherein the reformer is operated at a reformer operation temperature of from 500° C. to 850° C.

6. The process of claim 1, wherein the reformate is recovered from the reformer at a recovery temperature of at least 500° C.

7. The process of claim 1, wherein the water-gas shift reaction zone comprises a first stage and a second stage, wherein the first stage is operated at a temperature that is higher than the second stage and the feedstream is in heat exchange contact with one or more streams selected from a first stage water-gas shift product stream, a second-stage water-gas shift product stream, the reformate and combinations thereof.

8. The process of claim 1, wherein the feedstream is introduced into the reformer as vapor at a pressure of from 150 psi to 400 psi.

9. The process of claim 1 wherein the feedstream is introduced into the reformer in the absence of compression.

10. The process of claim 1, wherein the feedstream is introduced into the reformer at a steam to carbon molar ratio of from 2:1 to 4:1.

11. The process of claim 1, wherein the steam reforming catalyst comprises a metal component, a modified support and a promoter.

12. The process of claim 11 wherein the metal component comprises nickel in an amount of from 0.1 wt % to 60 wt %.

13. The process of claim 11 wherein the promoter comprises a rare earth element in an amount of from 0.1 wt % to 15 wt %.
